(19) United States
(12) Patent Application Publication
(10) Pub. No.: US 2026/0233585 A1
(43) Pub. Date: Aug. 13, 2026

(54) WINDOW UNIT, ASSEMBLED WINDOW UNIT, MOLD AND ASSOCIATED METHODS AND USE

(71) Applicant: AGC GLASS EUROPE, Louvain-la-Neuve (BE)

(72) Inventors: Jiri SKALA, Gosselies (BE); Sébastien DELNEUFCOURT, Gosselies (BE); Mirek STARINSKY, Gosselies (BE)

(73) Assignee: AGC GLASS EUROPE, Louvain-la-Neuve (BE)

(21) Appl. No.: 19/151,522

(22) PCT Filed: Feb. 5, 2024
(86) PCT No.: PCT/EP2024/052784

§ 371 Date: Jul. 28, 2025

(30) Foreign Application Priority Data
Feb. 10, 2023 (EP) 23156166.3

(51) Int. Cl. B60J 1/00; B29D 99/00; B29K 23/00; B60R 13/04; F16B 5/12

(52) U.S. Cl. CPC B60J 1/006; B29D 99/0007; B60R 13/04; F16B 5/126; B29K 2023/12; B60J 1/001

(57) ABSTRACT

A window unit having a glazing panel, and a frame which has a frame profile and encompasses the glazing panel's edge on at least one peripheral side and grips or encompasses the glazing panel on at least two peripheral sides in the form of a ring. The frame has a primary part, in the form of a hard component, that forms a single component with at least one clip-like assembly that has a first member and a second member. The at least one clip-like assembly is designed to plug and maintain a trim element's rigid lug between the first and second members. The first member is flexible substantially perpendicular to the plugged trim element's axis of penetration and oriented at angle, A1, between 20° and 60° from the plugged rigid lug's axis of penetration.

### TECHNICAL FIELD

The present invention relates to a window unit comprising a glazing panel, a frame which has a frame profile and encompasses the edge of the glazing panel on at least two peripheral sides, and grips the glazing panel or encompasses the glazing panel on at least two peripheral sides in the form of a ring; the frame comprising a primary part which is in the form of a hard component, in general and, more specifically, to an enhanced window unit comprising a trim element along a part of an edge.

Thus, the invention concerns multiple domains where a window unit comprising a at least one clip-like assembly to plug and to maintain a trim element along a part of an edge. Said window unit is designed to be mounted on a structure. The structure can be a fixed object such as a building or a bodywork of a mobile object such as a motor vehicle, a car, a bus, a truck, a train, a boat, or alike. Such window unit can be used outdoor as well as indoor.

### BACKGROUND ART

Constructors often mask these unattractive seals behind metallic trim elements or trim elements made from synthetic material coated with a metallic film. These trim elements have to be fastened sufficiently robustly such that there is no risk of their detaching accidentally. It must also be possible for them to be detached, for example at the time of work or during replacement of the trim in the event of a defect in the latter, thereby not requiring replacement of the full window/paint provided on the vehicle.

Various methods have been proposed for fastening these trim elements, these methods often involving a link between the seal and the trim. Usually, these fastenings are achieved by means of clip-type means so that installation is simple and quick. In these assembling operations, the trim, which essentially comprises a metallic profile, is fastened to a component incorporated into the seal itself. The positioning of the various elements often requires one or more operations that can be effected only manually, which is unsatisfactory from the economic standpoint. With a view to simplifying these operations, solutions have recourse to fastening methods comprising the clipping of the profile constituting the trim to a corresponding element integrated in the peripheral seal when the latter is formed on the window. In particular, Belgian patent application BE 2013/0441 has proposed a trim fastening comprising two distinct elements, the first element being a base molded directly with the seal and the second comprising clips designed to receive the lug of the trim. The second element, meanwhile, is assembled on the base by engagement of the two elements one relative to the other in a movement that opposes the separation of the two elements. This solution offers the advantage of it being possible to replace the second element if it is defective.

However, this solution leads to the formation of shrinkage cavities in the region of the seal when the fastening element is positioned.

To reduce this shrinkage cavities, the European patent application EP3461668 discloses a clip inserted on the glazing unit. This solution requires the assembly of parts (primary part, clips, . . . ) that are manufactured separately. This solution also requires a lot of handling to manufacture the glazing, while making the assembly with the trim element more complex.

The patent publication WO2022029000 discloses a glazing unit comprising a clip to clip a trim element. Said clip comprises an elongated flexible part and a rigid part to maintain the trim element. Each of the flexible part and the rigid part are substantially arranged parallel to the clipping direction and in the direction opposite to said clipping direction.

This solution is difficult to assemble due to this rigid part substantially arranged parallel to the clipping direction and in the direction opposite to said clipping direction. Positioning of the trim element has to be very precise to avoid breakage and to avoid high pressure on the flexible arm. High precision of the trim element bending is also needed. Thus, the handling is also complex due to an high risk of breakage of this elongated flexible part extending outside of the assembly.

On top of that, the tooling system to manufacture such window unit needs an high cost because of at least the undercut under rigid part.

Such solutions are almost impossible to unmount the trim element once installed (plugged).

There is a high risk of sinkmarks at the A-side of the trim element.

### SUMMARY OF INVENTION

Thus, to solve these problems, the present invention proposes an enhanced window unit.

The present invention relates, in a first aspect, to a window unit comprising a glazing panel and a frame which has a frame profile and encompasses the edge of the glazing panel on at least two peripheral sides, and grips the glazing panel or encompasses the glazing panel on at least one peripheral side, preferably on at least two peripheral sides, in the form of a ring. The frame comprises a primary part which is in the form of a hard component.

The solution as defined in the first aspect of the present invention is based on that the primary part of the frame comprises at least one clip-like assembly. The clip-like assembly comprises a first member and a second member. The at least one clip-like assembly being designed to plug and to maintain a rigid lug of a trim element between the first member and the second member.

The solution as defined in the first aspect of the present invention is also based on that the at least one clip-like assembly and the primary part are formed as a single component to at least reduce the handling.

The solution as defined in the first aspect of the present invention is also based on that the first member is designed to be flexible in a direction substantially perpendicular to the axis of penetration of a trim element to be plugged into the at least one clip-like assembly.

The solution as defined in the first aspect of the present invention is also based on that the first member is oriented from the axis of penetration of the rigid lug to be plugged into the at least one clip-like assembly by an angle A1 comprised between 20° and 60°, 20°≤A1≤60°, preferably the angle A1 is comprised between 30° and 55°, 30°≤A1≤55°, more preferably the angle A1 is comprised between 30° and 45°, 30°≤A1≤45° and even more preferably the angle A1 is about 40° to at least stabilize the plug of a rigid lug of a trim element into the at least one clip-like element.

The present invention relates, in a second aspect, to an assembled window unit comprising a window unit according to the first aspect of the present invention. The assembled window unit also comprises a trim element comprising at least one rigid lug designed to be plugged and maintained in a clip-like assembly.

The solution as defined in the second aspect of the present invention is based on that one of the at least one rigid lug is inserted into one of the at least one clip-like assembly. The one of the at least one rigid lug is inserted between the first member and the second member.

The present invention relates, in a third aspect, to a method to produce a window unit according to the first aspect of the invention, wherein the method comprises a step of injecting the primary part and the at least one clip-like assembly in a single step onto the glazing panel.

The present invention relates, in a fourth aspect, to a method to assemble an assembled glazing unit according to the second aspect of the invention, wherein the method comprises following steps:
Step A. Providing a glazing unit according to the first aspect of the invention;
Step B. Providing a trim element comprising at least one rigid lug designed to be plugged and maintained in a clip-like assembly;
Step C. Assembling the trim element by clipping one of the at least one rigid lug into one of the at least one clip-like assembly between the first member and the second member of the corresponding one of the at least one lug, preferably assembling the trim element by clipping each of the at least one rigid lug corresponding to a clip-like element into the corresponding clip-like assembly of the at least one clip-like assembly between the first member and the second member.

The present invention relates, in a fifth aspect, to a method to disassemble a trim element from a assembled window unit according to the second aspect of the invention wherein the method comprises a step of spreading the first member to unplug the lug of the trim element by reducing the angle A1.

The present invention relates, in a sixth aspect, to a mold to produce a window unit according to the first aspect of the present invention, the mold being designed to receive at least a part of the glazing unit on which the primary part will be inserted, characterized in that the mold comprises a cavity to create by injection the primary part and the at least one clip-like assembly.

The present invention relates, in a seventh aspect, to an use to clip a trim element with an at least one clip-like assembly comprised in a primary part of a frame which has a frame profile and encompasses the edge of a glazing panel on at least one peripheral side; the frame comprising a primary part (4) which is in the form of a hard component; ), the at least one clip-like assembly being designed to plug and to maintain a rigid lug of a trim element between the first member and the second member, the at least one clip-like assembly and the primary part being formed as a single component, the first member being designed to be flexible in a direction substantially perpendicular to the axis of penetration of a trim element to be plugged into the at least one clip-like assembly; the first member being oriented from the axis of penetration of the rigid lug to be plugged into the at least one clip-like assembly by an angle A1 comprised between 20° and 60°, 20°≤A1≤60°, preferably the angle A1 is comprised between 30° and 55°, 30°≤A1≤55°, more preferably the angle A1 is comprised between 30° and 45°, 30°≤A1≤45° and even more preferably the angle A1 is about 40°.

Thus, the invention, through the different aspects of which it is composed, make it possible to solve the need to easily plug, maintain a trim element along a window unit while having the possibility to change this trim element with an easy handling and easy replacement of the already-mounted trim element.

The invention permits to obtain a robust and dimensionally stable window unit.

It is noted that the invention relates to all possible combinations of features recited in the claims or in the described embodiments.

The following description relates to automotive but it's understood that the invention may be applicable to others fields like transportation applications in general or building applications or alike.

### BRIEF DESCRIPTION OF THE DRAWINGS

This and other aspects of the present invention will now be described in more detail, with reference to the appended drawings showing various exemplifying embodiments of the invention which are provided by way of illustration and not of limitation. The drawings are a schematic representation and not true to scale. The drawings do not restrict the invention in any way. More advantages will be explained with examples.

FIG. 1 is a schematic view of a part of a window unit according to the first aspect of the invention

FIG. 2 is a schematic 3D view of a part of a window unit in a first embodiment according to the first aspect of the invention.

FIG. 3 is a schematic 3D view of a part of an assembled window unit corresponding to the window unit of FIG. 2.

FIG. 4 is a schematic 3D view in the zoom ZA of a rigid lug plugged into the corresponding clip-like assembly according to the invention.

FIG. 5 is a schematic sectional view of a clip-like assembly of FIG. 4 along plane AA′

FIG. 6 is a schematic 3D view of a part of a window unit in a second embodiment according to the first aspect of the invention.

FIG. 7 is a schematic 3D view of a part of an assembled window unit corresponding to the window unit of FIG. 6.

FIG. 8 is a schematic 3D view in the zoom ZB of a clip-like assembly according to the invention.

FIG. 9 is a schematic 3D view in the zoom ZB of a rigid lug plugged into the corresponding clip-like assembly according to the invention

FIG. 10 is a schematic sectional view of a clip-like assembly of FIG. 9 along plane BB′.

FIG. 11 is a schematic view of a method according to the fourth aspect of the present invention.

FIG. 12 is a schematic view of sub steps of step C according to the fourth aspect of the present invention

### DETAILED DESCRIPTION

In this document to a specific embodiment and include various changes, equivalents, and/or replacements of a corresponding embodiment. The same reference numbers are used throughout the drawings to refer to the same or like parts. Other variations can be envisaged within the scope of the claims.

As used herein, spatial or directional terms, such as “inner”, “outer”, “above”, “below”, “top”, “bottom”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims are approximations that can vary depending upon the desired properties sought to be obtained by the present invention. In the following description, unless otherwise specified, expression “substantially” mean to within 10%, preferably to within 5%.

Moreover, all ranges disclosed herein are to be understood to be inclusive of the beginning and ending range values and to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Further, as used herein, the terms “deposited over” or “provided over” mean deposited or provided on but not necessarily in surface contact with. For example, a coating “deposited over” a substrate does not preclude the presence of one or more other coating films of the same or different composition located between the deposited coating and the substrate.

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated. In this document, “configured to (or set to)” may be interchangeably used in hardware and software with, for example, “appropriate to”, “having a capability to”, “changed to”, “made to”, “capable of”, or “designed to” according to a situation. In any situation, an expression “device configured to do” may mean that the device “can do” together with another device or component.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated. herein. When it is described that a constituent element (e.g., a first constituent element) is “(functionally or communicatively) coupled to” or is “connected to” another constituent element (e.g., a second constituent element), it should be understood that the constituent element may be directly connected to the another constituent element or may be connected to the another constituent element through another constituent element (e.g., a third constituent element).

It is an object of the present invention to alleviate the above described problems.

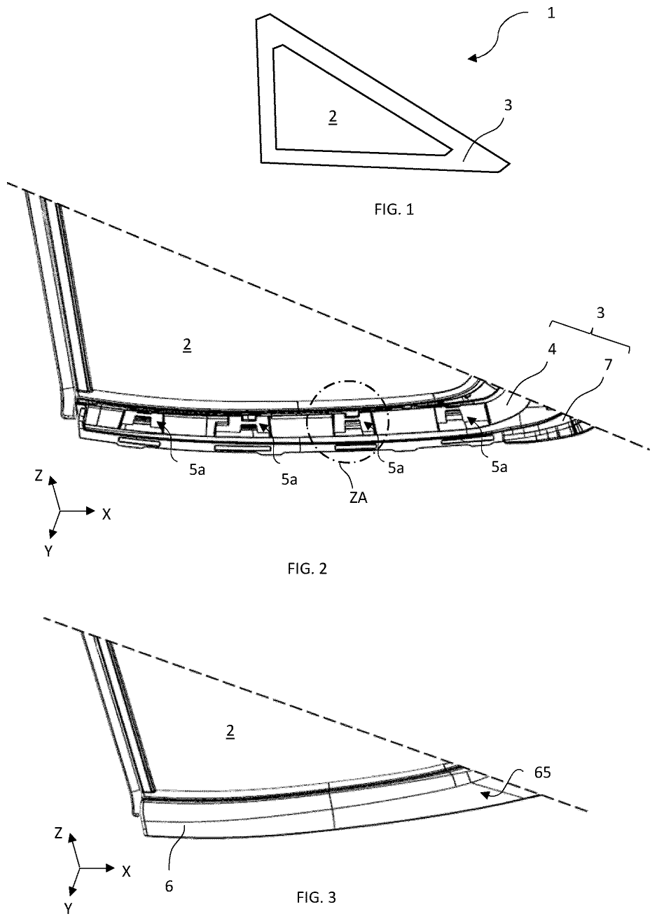

According to a first aspect of the invention, as illustrated in FIG. 1, the invention relates to a window unit 1 comprising a glazing panel 2 and a frame 3.

### Glazing Panel

In one embodiment, the glazing panel can comprises at least one glass sheet.

In another embodiments, due to reduction of induced deformations on the glazing panel, the glazing panel can comprise a laminated glass panel. The laminated glass panel comprises glass sheets maintained by one or more interlayers positioned between glass sheets. The interlayers employed are typically polyvinyl butyral (PVB) or ethylene-vinyl acetate (EVA) for which the stiffness can be tuned. These interlayers keep the glass sheets bonded together even when broken in such a way that they prevent the glass from breaking up into large sharp pieces.

The material of the glass sheet can independently be, for example, soda-lime silica glass, borosilicate glass, aluminosilicate glass or other materials such as thermoplastic polymers or polycarbonates which are especially known for automotive applications. References to glass throughout this application should not be regarded as limiting.

The glass sheet can independently be a clear glass or a coloured glass, tinted with a specific composition of the glass or by applying a decorative coating, paint or a plastic layer for example. The glass sheet can have any shape to fit to the opening such as a rectangular shape, in a plan view by using a known cutting method. As a method of cutting the glass sheet, for example, a method in which laser light is irradiated on the surface of the multi-glazed window to cut the glass sheet, or a method in which a cutter wheel is mechanically cutting can be used.

The glass sheet can independently be manufactured by a known manufacturing method such as a float method, a fusion method, a redraw method, a press molding method, or a pulling method. As a manufacturing method of the glass sheet, from the viewpoint of productivity and cost, it is preferable to use the float method.

In the case of a laminated glass panel, it could be advantageous to have varying thicknesses of glass sheets to reduce weight and noise. Due to of induced deformations on the glazing panel, thin glass sheets with a thickness less than 1 mm can be used without be bent or deformed. Thus, such thin glass sheet can keep the desired design.

The shape of the window unit in a plan view (in the X-Z plane) is usually a triangle, especially for a window unit used as a quarterlight window unit. Depending of the application, the shape is not limited to a triangle and may be a rectangle, a trapeze, a circular-shape, a hex or the like.

The glazing panel can be a flat or curved panel to fit with the design of the car. The glazing panel can be processed, ie annealed, tempered, . . . to respect with the specifications of security and anti-thief requirements. A heatable system, for example a coating or a network of wires, can be applied on the glazing panel to add a defrosting and/or a demisting function for example.

### Frame

According to the invention, the frame 3, which has a frame profile and encompasses the edge of the glazing panel on at least one peripheral side.

In some embodiments the frame can grip the glazing panel or encompasses the glazing panel on at least two peripheral sides in the form of a ring.

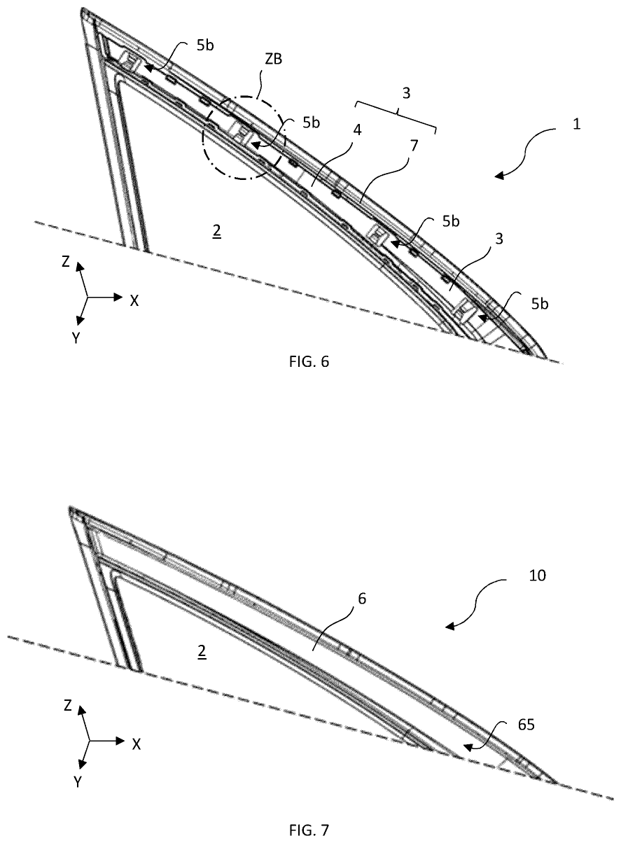

As illustrated in FIG. 2 and FIG. 6, the frame comprises a primary part 4 which is in the form of a hard component. It is understood that a hard component is a component dimensionally stable with a young modulus higher than 1000 MPa, preferably the hard component is a component dimensionally stable with a young modulus higher than 1500 MPa.

### Primary Part

In a preferred embodiment, the hard component is a polypropylene based material. Other hard materials, with a young modulus higher than 1000 MPa, as polyamide, specific styrenic, ABS, specific PVC and others can be also used.

In some preferred embodiments, the hard component can be reinforced with fillers (glass fibres, glass beads, calcium carbonate, talc, silica, wollastonite, clay, calcium sulphate fibres, mica), i.e. a polypropylene reinforced with 30% of glass fibers (PP 30 GF) having a young modulus higher than 1500 MPa, about 1680 MPa.

In one embodiment of the invention, the primary part is in direct contact with the glazing panel meaning that the primary part is injected onto the glazing panel directly without any other material between the primary part and the surface of the glazing panel. The glazing panel can have locally a bonding agent or primer material to ensure tightness and/or to promote the encapsulation of the primary part onto the glazing panel.

The primary part can be overmolded on the glazing panel. To facilitate the process, the primary part is preferably injected into a mold to be encapsulated on the glazing panel.

The primary part can have a specific shape to fulfil with the requirement of the desired application. In some embodiments, the primary part can have extensions 41 to ensure the mechanical strength of the window unit.

### Secondary Part

In one embodiment of the invention, the frame can comprise a secondary part 7 which is in the form of soft component, placed at least partially over the primary part. The secondary part allows to thigh the window unit on the structure where it is fixed. Such structure can be a car body, a building, . . .

The secondary part can be injected in a step, done after the step of injecting the primary part, over at least partially the primary part. Preferably, the secondary part is a single part. In some embodiments, the secondary part can be locally in contact with the glazing panel to ensure the aesthetic and the tightness of the window unit.

In another embodiment, at least a portion of the secondary part is in contact with the glazing panel and preferably at least in contact with the glazing panel at the level of the at least one constraints releasing mean.

The soft component has a natural chemical cohesive bonding with the hard component.

The soft component has a young modulus lower than 1000 MPa. The soft material, which has a young modulus lower than 1000 MPa can be made of thermoplastic elastomer based material. Styrenic based and vulcanized thermoplastics elastomer are generally used. The soft component is in another embodiment a soft polyvinyl chloride.

The soft component is used to give the final surface aspect of the frame and also to fit the window unit to the car body. Effectively, the softness of the material allow interferences between the carbody and the window unit by the use of soft lips. Soft component is sometimes also used to insure a sealing function between the carbody and the encapsulated window unit.

In a preferred embodiment, the soft component is a thermoplastic elastomer (TPE) based material.

According to one embodiment of the present invention, the frame profile encompassing the edge of the glazing panel on at least one peripheral side and is made of soft component which has a natural chemical cohesive bonding with the hard material. Thus, a good adhesion between the frame profile and the primary part may be obtained without using a primer between the two parts.

FIG. 2 and FIG. 7 illustrate a part of an assembled window unit 10 to be mounted on a bodywork of a vehicle such as a car. The assembled window unit 10 comprises a window unit as described above.

### Trim Element

The assembled window unit also comprises a trim element 6.

In this representation, the trim element 6 has an exterior surface 65 designed to mask a part of the primary part 4, and a part of the secondary part if exists.

The trim element is generally an elongated element, substantially parallel to the edge of the glazing unit with a well finished exterior surface 65.

The trim element can be flat or curved. The trim element can have any shape in order to mask the part of the window unit that should not be visible once mounted on a structure.

The trim element can be made of plastic-based material or a metal such as aluminium.

The trim element can have a coating, a film, or alike on the external surface for aesthetic reasons such as matching with the colour of the structure or giving a specific finish aspect.

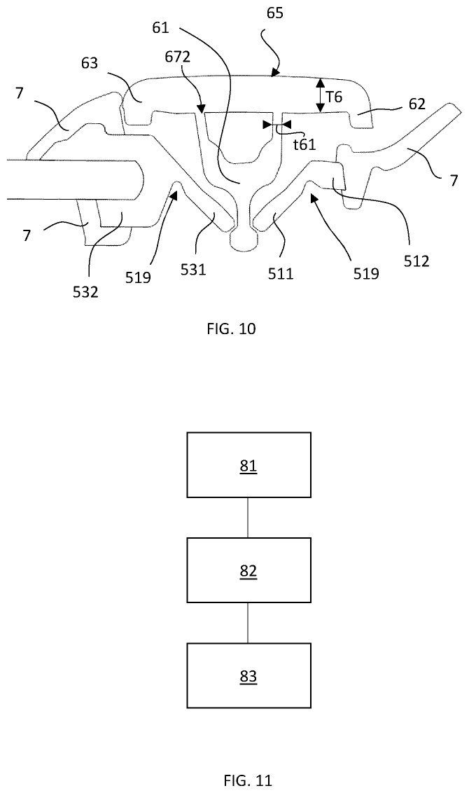

As illustrated in FIG. 5 and FIG. 10, on the internal face 66 that is turned toward the seal, the trim element comprises a rigid lug 61. The trim element can comprises extensions 62, 63 that permits to well positioned the trim element between the bodywork and the window unit and/or permits to reinforced the trim element.

According to the invention, a rigid lug means that the lug is not flexible to be able to plug it into the first and the second members.

According to the invention, the rigid lug can have any shape that able to be plugged and maintained in the clip-like assembly.

Coming back to FIG. 2 to FIG. 5 illustrating some embodiments of the present invention, the primary part of the frame comprises at least one clip-like assembly 5a.

FIG. 2 illustrates an embodiment in which the primary part comprises, in the shown portion, four clip-like assemblies 5a. It is understood that depending on the length and the specific application, the number of clip-like assemblies can vary from one to the desired number of clip-like assemblies.

### Clip-Like Assembly

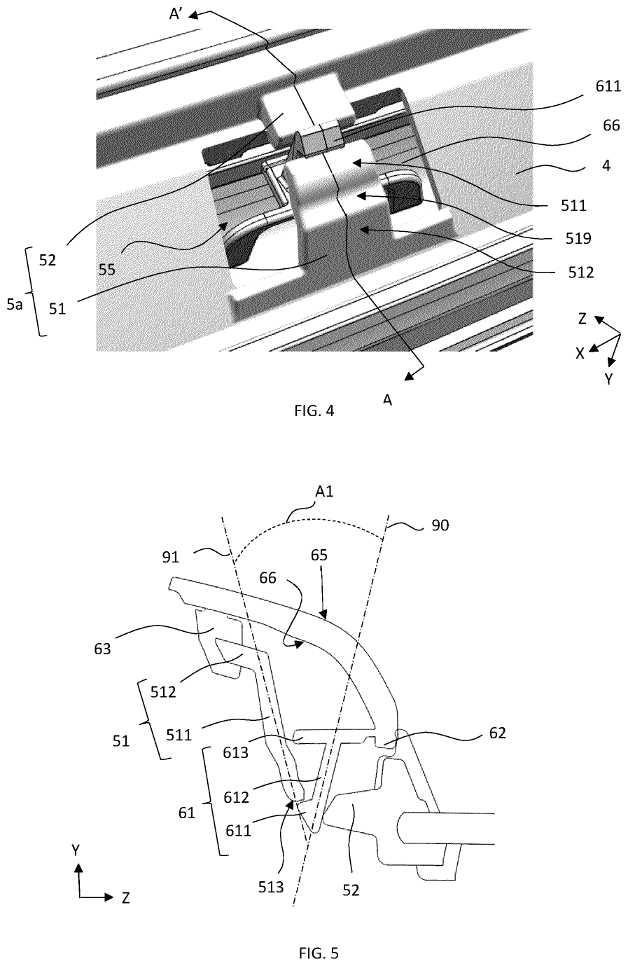

As illustrated in FIG. 4 and FIG. 5, the primary part 4 of the frame 3 comprises at least one clip-like assembly 5.

In some preferred embodiments, the primary part comprises at least two clip-like elements arranged to stabilise a trim element to plug into.

In some embodiments, depending on the desired application, and especially the length, measured along the glazing panel, of the trim element to plug into, the primary part 4 can comprises as many clip-like elements 5a, 5b as necessary along the edge of the window unit to hidden by a trim element.

According to the invention, the at least one clip-like assembly 5a and the primary part 4 are formed as a single component. That means that the at least one clip-like assembly 5 and the primary part 4 are produced with the same material and during a single step.

the clip-like assembly comprises a first member 51 and a second member 52. The at least one clip-like assembly is designed to plug and to maintain a rigid lug 61 of a trim element 6 between the first member 51 and the second member 52.

It is understood that the first and the second members are aligned to plug the rigid lug.

It is understood that the clipping or the plugging of a trim element is performed by the first member 51 and a second member 52, there is no need for another element, designed to clip to plug and to maintain a trim element into the clip-like element, of the clip-like element.

### First Member

The first member is designed to be flexible in a direction substantially perpendicular to the axis of penetration of a trim element to be plugged into the clip-like assembly. The means the first member is designed to not break during plugging or unplugging and the flexibility of the first member has to allow the bending during insertion of the head 611 in direction substantially perpendicular to Y-axis.

The term flexible means that the member has a elasticity factor higher than 30 mm, the elasticity factor being defined as the square of the average length of the arm divided by the average thickness of the member to allow the at least the head 611 to pass on the other side of the first member.

In this representation, the axis of penetration is substantially along the Y-axis and thus perpendicular to locally the edge of the window unit, the X-axis in such representations.

FIG. 4 and FIG. 5 illustrate a first member 51 designed to be flexible and a second member 52 designed to be rigid.

The term rigid means that the member/element cannot move and is dimensionally stable.

In some embodiments, the first member 51 can have an arm 511 designed to be flexible in a direction substantially perpendicular to the axis of penetration of a rigid lug 61 to be plugged into the clip-like assembly even if the bottom element is made of a rigid material such as Polypropylene, meaning that the shape, the length, the thickness and/or the width can vary depending on the application and on the trim element to plug. The first member can also comprises an end part 513. The end part can comprises a hook-like element to maintain a trim element once the trim element is plugged into the clip-like assembly. The end part is designed in combination with the end part 611 of the rigid lug to maintain the rigid lug between the first and the second member. The end part 611 can comprises a hook-like element to maintain the rigid lug once the trim element is plugged into the clip-like assembly, the end part 513 can be a flat-like surface or an inverted hook-like for example.

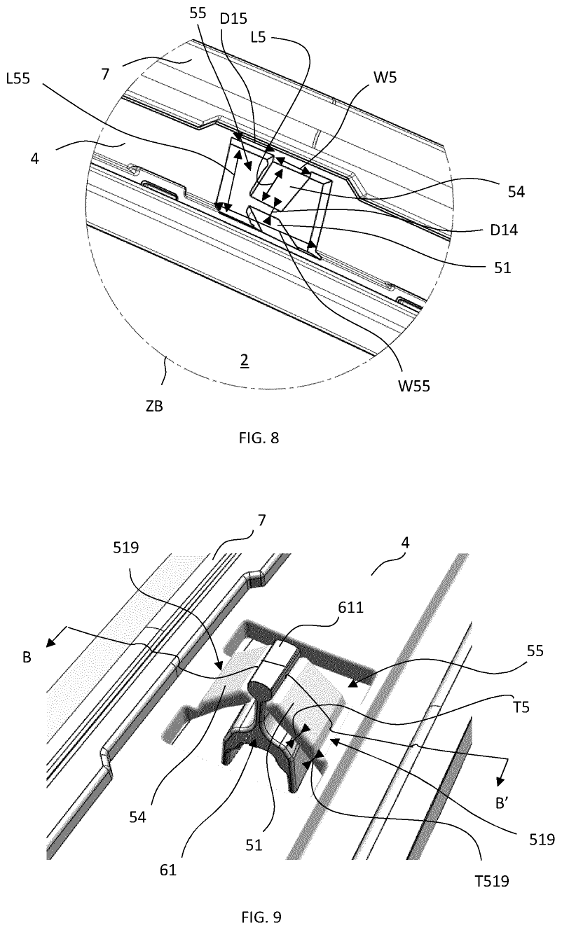

Preferably, as illustrated in FIG. 4, FIG. 8 and FIG. 9, around the first and the second member, the clip-like assembly comprises an opening 55 to facilitate the mounting and/or unmounting of a trim element. The opening permits to create a specific 3D shape for the first member and for the second member to ensure the individual flexibility of the top element and of the bottom element.

According to some embodiments, the opening can have a generic rectangular shape, as illustrated in FIG. 8 and FIG. 9, with a length L55, wherein 10 mm≤L55≤15 mm and a width W55, wherein 12 mm≤W55≤24 mm.

In some preferred embodiments, L55 is about 12.5 mm.

In some preferred embodiments, W55 is about 18 mm.

In some embodiments, the distance D15 between the border of the opening and the arm is comprised between 4 mm and 8 mm, 4 mm≤D15≤8 mm.

In some preferred embodiments, D15 is about 6 mm.

In some embodiments, the first member can have an arm 511 designed to be flexible in a direction substantially perpendicular to the axis of penetration of the rigid lug 61of a trim element to be plugged into the clip-like assembly even if the first member is made of a rigid material such as Polypropylene, meaning that the shape, the length, the thickness and/or the width can vary depending on the application and on the trim element to plug.

According to the invention, as illustrated in FIG. 5, the first member 51, and at least the arm 511, is oriented from the axis of penetration (90) of the rigid lug to be plugged into the at least one clip-like assembly by an angle A1 comprised between 20° and 60°, 20°≤A1≤60°. Preferably, the angle A1 is greater than or equal to 30° and the angle A1 is lower than or equal to 45°.

The angle A1 is measured between the axis of penetration 90 and the axis 91 of the arm 511 of the first member in the plane Y-Z.

In some embodiments, the angle A1 is comprised between 30° and 55°, 30°≤A1≤55°, more preferably the angle A1 is comprised between 30° and 45°, 30°≤A1≤45° and even more preferably the angle A1 is about 40°.

This angle A1 allows the rigid lug to be guided during the penetration without having a tooling with a high precision while the angle allows to reduce the needed flexibility of at least the arm 511 and ensuring a mechanical anchoring of the end part 611 of the rigid lug on the end part 513 of the first member. The arm is oriented in the same direction that the penetration direction of the rigid lug.

The first member can comprises a zone 519 having a reduced thickness T519 over its width, as shown in FIG. 4, between the arm 511 and the base 512 to facilitate the plug of the rigid lug by increasing the flexibility of the arm without changing the stiffness of the material used.

It is understood that the flexibility of the arm (thus the flexibility of the first member) is an elastic flexibility meaning that the position and the angle A1 returns to its resting position if no effort is applied. Then, during the insertion of a rigid lug, the arm moves by increasing the angle A1 and then coming back near to its resting position after the inserting to block the rigid lug between the first and the second members.

In some embodiments, as illustrated in FIG. 6 to 10, the second member can be similar to the first member meaning that the second member can be designed to be flexible in a direction substantially perpendicular to the axis of penetration of a trim element to be plugged into the at least one clip-like assembly.

FIG. 8 illustrates some embodiments where the first member 51 and the second member 54 are designed flexible.

In such embodiments, as the first member 51, preferably, the second member 54, especially the arm of the second member, is oriented from the axis of penetration of a trim element to be plugged into the at least one clip-like assembly by an angle A2 comprised between 20° and 60°, 20°≤A1≤60°, preferably the angle A2 is comprised between 30° and 55°, more preferably the angle A2 is comprised between 30° and 45°, 30°≤A1≤45° and even more preferably the angle A2 is about 40°. Thus, deformation during assembly is split between two flexible arms and then between the first and the second members while guiding a rigid lug to be plugged.

In some preferred embodiments, the angle A2 substantially equals to angle A1 to facilitate the plug of the rigid lug. Then, the trim element can be partially out of the final position.

In some preferred embodiments, as illustrated in FIG. 8 and FIG. 9, the first member 51 and/or the second member 52 can have a generic tongue-like shape having a length L5, wherein 5.0 mm≤L5≤10.0 mm, a width W5, wherein 4.0 mm≤L5≤8.0 mm and a thickness T5, wherein 1.2 mm≤T5≤2.0 mm.

In some preferred embodiments, L5 is about 7.5 mm.

In some preferred embodiments, W5 is about 6.0 mm.

In some preferred embodiments, T5 is about 1.5 mm.

In some preferred embodiments, the distance T519 between the end of the first member and the second member is comprised between 1.0 mm and 1.5 mm, 1.0 mm≤T5≤1.5 mm and more preferably, the distance T519 between the end of the first member and the second member is about 1.0 mm.

As illustrated in FIG. 9 and FIG. 10, the rigid lug can have an end element 611 in a shape designed to be blocked by each of the first and second members.

The rigid lug can have any shape especially a shape to reinforce its stiffness as illustrated in FIGS. 9 and 10 where the rigid lug as a generic bridge-shape, with two legs, with an elongated portion ended with the end part.

To avoid sinkmarks, as illustrated in FIG. 10, according to some preferred embodiments, legs of the trim element can be attached or produced on the internal face 66 of the trim element. In such embodiments, The thickness t61 of the legs is preferably smaller than or equals to the third of the thickness T6 measured between the exterior surface 65 and the internal face 66 of the trim element, t61≤⅓*T6.

In some embodiments, T6 is comprises between 2.5 mm and 4.0 mm, 2.5 mm≤T6≤4.0 mm. In preferred embodiments, T6 is about 3.0 mm and t61 is max 1.0 mm.

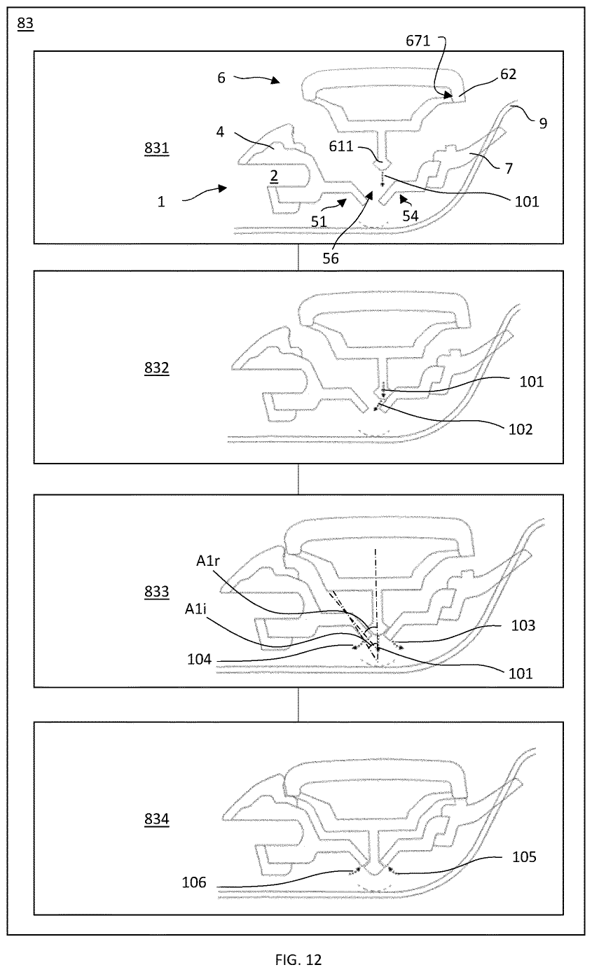

To avoid sinkmarks, as illustrated in FIG. 12, according to some other preferred embodiments, legs of the trim element can also be attached or produced at the external part 671 of the internal face 66 at next to the stopper element 62.

In some embodiments, each of the first and second members comprises a base and an arm. Each of the first and second members can comprise a reduced thickness 519, 539 over its width, as shown in FIG. 10, between the arm 511, 531 and the base 512, 532 to facilitate the plug of the rigid lug by increasing the flexibility of the arm without changing the stiffness of the material used.

As illustrated in figures, the at least one clip-like assembly and the primary part are formed as a single component. That means that the at least one clip-like assembly is part of the primary part and the at least one clip-like element is created during the injection of the primary part and with the primary part. Thus, the at least one clip-like element is made of the same component than the primary part.

In such representations, the top element 51 is alone on one side of the tongue-like element 53 such as the bottom element 52 on the other side, meaning that there is no other element designed to plug and to maintain the trim element in front of, in the Z-axis, the top element and in front of, in the Z-axis, the bottom element. The plug of the trim element is done, for one clip-like element, only by the top element and the bottom element.

The rigid lug 61 is inserted into the at least one clip-like assembly to be plugged and maintained on the window unit.

The present invention relates also to a method to produce a window unit according to the first aspect, wherein the method comprises a step of injecting the primary part and the at least one clip-like assembly in a single step onto the glazing panel.

Preferably, the step of injecting is preceded by a step of inserting the glazing panel into a mold.

The present invention also relates to a mold to produce a window unit according to the first aspect. The mold is designed to receive at least a part of the glazing unit on which the primary part will be inserted. It is understood that only the part of the glazing panel to be injected or the whole glazing panel can be inserted into the mold.

According to the invention, the mold comprises a cavity to create by an injection the primary part and the at least one clip-like assembly in a single step.

The mold comprises a top part and a bottom part. The parts can close up creating the cavity. The cavity is sealed once the parts are closed. The mold comprises at least one injection nozzle to inject into the cavity the primary part.

The present invention also relates to a method to assemble a vehicle glazing unit according to the second aspect of the invention, as illustrated in FIG. 11. Said method comprises following steps:
Step A. Providing (81) a window unit according to the first aspect of the invention;
Step B. Providing (82) a trim element comprising a rigid lug designed to be plugged and maintained in a clip-like assembly;
Step C. Assembling (83) the trim element by clipping one of the at least one rigid lug into one of the at least one clip-like assembly between the first member and the second member of the corresponding one of the at least one lug, preferably assembling the trim element by clipping each of the at least one rigid lug corresponding to a clip-like element into the corresponding clip-like assembly of the at least one clip-like assembly between the first member and the second member

In embodiments with a single rigid lug, step C correspond to assembling the trim element by clipping the lug between the top element and the bottom element of the at least one clip-like element.

As illustrated in FIG. 12, the step C can comprise several sub-steps 831, 832, 833, 834.

The sub-step 831 is a sub-step of presenting a trim element with the at least one rigid lug in front of the corresponding at least one clip-like assembly. Thanks to the design of the first and second members, it is not necessary to position the rigid lug strictly in the perfect position. After presenting the trim element, the trim element is inserted between the first and second members, especially between the arm of the first member 51 and the arm of the second member 54 into the pocket 56 created between said arms.

The sub-step 832 is a sub-step of continuing the inserting while self-centring 102 the rigid lug to be perfectly centred by sliding on one of the arms.

The sub-step 833 is a sub-step of continuing the inserting. The pressing of the end of the rigid lug opens arms by reducing temporarily the angle A1 and the angle A2 meaning that the end of arms is moving away from the rigid lug in the direction 103, 104 substantially perpendicular to the inserting direction 101. The angle A1 passes from the rest position from angle A1=A1r to a temporary insertion position with the angle A1=A1i where A1r>A1i. This is the same for angle A2.

The sub-step 834 is a sub-step of blocking the trim element to form a assembled window unit. The end part of the rigid lug is passed over the end part of arms then thanks to the elastic flexibility of the arms of the first member and second member, arms are trying to get back to their rest position meaning that angle A1 passes from the temporary insertion position with the angle A1=A1i where A1r>A1i to substantially the rest position with an angle A1=A1r. In such embodiments, the behaviour of angle A2 is similar to the behaviour of angle A1. The return to a position close to the rest position makes it possible to block rigid lugs of the trim element between the corresponding clip-like element and especially between the first member and the second member.

As illustrated in FIG. 12, the window unit can be assembled to a vehicle having a car body 9 before assembling the trim element on the window unit.

The present invention provides also a method to disassemble a trim element from a assembled window unit obtained by the method illustrated in FIG. 11 and FIG. 12. Said method comprises a step of spreading the first member to unplug the lug of the trim element by increasing the angle A1 to let the blocked part of the rigid lug to get out of the clip-like element. Arms can be accessible from rear side of the assembled window unit. Arms are able to be opened by a rotation of a screwdriver or another jig by changing the angle A1 from A1r to substantially A1i.

This permits to change only the trim element if needed without changing the whole assembled window unit and thus saving money and material.

Indeed, the invention solves drawbacks of the prior art especially by allowing easy assembly, by reducing the tool costs, by giving the possibility to change the trim element easily without changing the whole assembled window unit, by reducing the risk of breakage of members of the clip-like element, by preventing sinkmarks at a side, by giving the possibility to have a less precise assembly and thus reducing costs and while allowing a good precision of the plugged position.

On top of that, the invention can be implemented for each fixation method to save addons (screws, tapes, clips, etc.).

1: A window unit comprising:
a glazing panel,
a frame which has a frame profile and encompasses an edge of the glazing panel on at least one peripheral side; the frame comprising a primary part which is in a form of a hard component,
wherein
the primary part of the frame comprises at least one clip-like assembly the clip-like assembly further comprises a first member and a second member, the at least one clip-like assembly being designed to plug and to maintain a rigid lug of a trim element between the first member and the second member,
the at least one clip-like assembly and the primary part are formed as a single component,
the first member is designed to be flexible in a direction substantially perpendicular to an axis of penetration of the trim element to be plugged into the at least one clip-like assembly,
the first member is oriented from the axis of penetration of the rigid lug to be plugged into the at least one clip-like assembly by an angle A1 between 20° and 60°, 20°≤A1≤60°, and
the second member is oriented from the axis of penetration of the trim element to be plugged into the at least one clip-like assembly by an angle A2 between 20° and 60°, 20°≤A2≤60°.

2: The window unit according to claim 1, wherein the second member is designed to be flexible in a direction substantially perpendicular to the axis of penetration of the trim element to be plugged into the at least one clip-like assembly.

3: The window unit according to claim 1, wherein the hard component is a polypropylene based material.

4: The window unit according to claim 1, wherein the frame comprises a secondary part which is in a form of a soft component, placed at least partially over the primary part.

5: The window unit according to claim 3, wherein the soft component is a thermoplastic elastomer based material.

6: The window unit according claim 1, wherein the primary part is in direct contact with the glazing panel.

7: The window unit according to claim 1, wherein the glazing panel comprises a glass panel.

8: The window unit according to claim 1, wherein the glazing panel comprises a laminated glass panel.

9: An assembled window unit comprising:
the window unit according to claim 1,
the trim element comprising at least one rigid lug designed to be plugged and maintained in at least one clip-like assembly,
wherein one of the at least one rigid lug is inserted into one of the at least one clip-like assembly between the first member and the second member.

10: A method to produce a window unit according to claim 1, wherein the method comprises injecting the primary part and the at least one clip-like assembly in a single step onto the glazing panel.

11: A method to assemble an assembled window unit according to claim 9, wherein the method comprises;
Providing the window unit produced by the method of claim 10;
Providing the trim element; and
Assembling the trim element by clipping one of the at least one rigid lug into one of the at least one clip-like assembly between the first member and the second member of the corresponding one of the at least one lug.

12: A method to disassemble a trim element from an assembled window unit according to claim 9, wherein the method comprises spreading the first member to unplug the lug of the trim element by decreasing the angle A1.

13: A mold to produce a window unit according to claim 1, the mold being designed to receive at least a part of the glazing unit on which the primary part will be inserted, wherein the mold comprises a cavity to create by injection the primary part and the at least one clip-like assembly.

14: The window unit according to claim 1, wherein the frame encompasses the edge of the glazing panel on at least two peripheral sides.

15: The window unit according to claim 1, wherein the angle A1 is between 30° and 55°, 30°≤A1≤55°.

16: The window unit according to claim 1, wherein the angle A1 is between 30° and 45°, 30°≤A1≤45°.

17: The window unit according to claim 1, wherein the angle A2 is between 30° and 55°, 30°≤A2≤55°.

18: The window unit according to claim 1, wherein the angle A2 is between 30° and 45°, 30°≤A2≤45°.

19: The window unit according to claim 1, wherein the hard component is a polypropylene based material filled with glass-fibres.

20: The method to assemble an assembled window unit according to claim 11, wherein the trim element is assembled by clipping each of the at least one rigid lug corresponding to the clip-like element into the corresponding clip-like assembly of the at least one clip-like assembly between the first member and the second member.
